(19) United States
(12) Patent Application Publication
(10) Pub. No.: US 2013/0115798 A1
(43) Pub. Date: May 9, 2013

(54) RECEPTACLE CONNECTOR

(71) Applicant: Hung-Chi Wang, New Taipei (TW)

(72) Inventor: Hung-Chi Wang, New Taipei (TW)

(21) Appl. No.: 13/292,082

(22) Filed: Nov. 9, 2011

(51) Int. Cl. H01R 13/62

(52) U.S. Cl. 439/345

(57) ABSTRACT

A receptacle connector includes an insulating housing defining a receiving chamber having a front opened freely, and positioning fillisters each longitudinally opened in a bottom wall of the receiving chamber. Two fastening fillisters are oppositely concaved into two opposite inner sides of the positioning fillister. A plurality of electrical terminals each has a base arm disposed in the positioning fillister and a contact arm extending upward from a front end of the base arm and inclined rearward at an acute angle with respect to the base arm. The contact arm stretches into the receiving chamber. The front end of the base arm has two opposite side edges protruded outward to form two fastening ears stabbed in fronts of the fastening fillisters to avoid the front end of the base arm curling upward and rearward when a plug connector is inserted into the receiving chamber.

### BACKGROUND OF THE INVENTION

1. Field of the Invention

The present invention generally relates to an electrical connector, and more particularly to a receptacle connector.

2. The Related Art

A traditional receptacle connector adapted for connecting with a mating plug connector includes an insulating housing defining a receiving chamber penetrating through a mating surface thereof for receiving the plug connector therein, and a plurality of terminals disposed in the insulating housing and stretching into the receiving chamber for electrically connecting with the plug connector. However, while the plug connector is inserted into the receiving chamber of the receptacle connector, mating ends of the terminals are apt to be curled by insertion force of the plug connector on account of having no any fastening structures thereon. As a result, the terminals may be easily broken off and bring about a poor electrical connection between the receptacle connector and the plug connector. Therefore, a receptacle connector capable of overcoming the foregoing problem is required.

### SUMMARY OF THE INVENTION

An object of the present invention is to provide a receptacle connector adapted to connect with a mating plug connector. The receptacle connector includes an insulating housing and a plurality of electrical terminals. The insulating housing defines a receiving chamber having a front opened freely for receiving the plug connector therein, and a plurality of terminal fillisters communicated with the receiving chamber. The terminal fillisters are transversely arranged at regular intervals in a bottom wall of the receiving chamber and each further extends longitudinally to penetrate through a rear wall of the receiving chamber. Each of the terminal fillisters includes a positioning fillister longitudinally opened on the bottom wall and a pair of fastening fillisters oppositely concaved inward into two opposite inner sides of the positioning fillister. Each of the electrical terminals has a base arm disposed in the positioning fillister of the insulating housing, a soldering tail formed at a rear end of the base arm to stretch behind the insulating housing, and a contact arm extending upward from a front end of the base arm and inclined rearward at an acute angle with respect to the base arm. The contact arm stretches into the receiving chamber for electrically connecting with the plug connector. The front end of the base arm has two opposite side edges thereof oppositely protruded outward to form a pair of fastening ears adjacent to the contact arm. The fastening ears are stabbed in fronts of the fastening fillisters to avoid the front end of the base arm curling upward and rearward when the plug connector is inserted into the receiving chamber.

As described above, the fastening ears are oppositely protruded at the two opposite side edges of the front end of the base arm and further stabbed in the fronts of the fastening fillisters, so as to prevent the front end of the base arm from curling upward and rearward when the mating plug connector is inserted into the receiving chamber to press the contact arms downward. So, it reduces fracture probability of the electrical terminal and further prolongs use life of the electrical terminal so as to realize a steady connection between the receptacle connector and the plug connector.

### BRIEF DESCRIPTION OF THE DRAWINGS

The present invention will be apparent to those skilled in the art by reading the following description, with reference to the attached drawings, in which:

FIG. 1 is an assembled perspective view of a receptacle connector in accordance with an embodiment of the present invention;

FIG. 2 is an exploded perspective view of the receptacle connector of FIG. 1; and

FIG. 3 is a sectional view of an insulating housing of the receptacle connector of FIG. 1.

### DETAILED DESCRIPTION OF THE PREFERRED EMBODIMENT

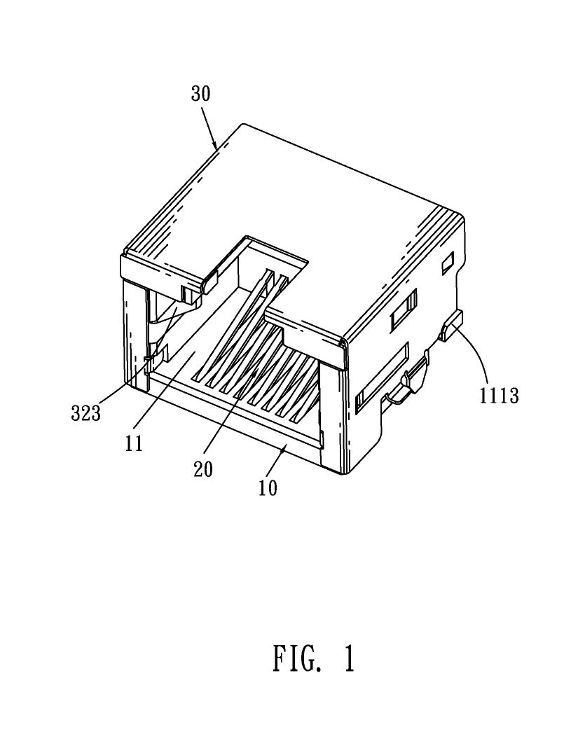

With reference to FIG. 1, a receptacle connector according to an embodiment of the present invention includes an insulating housing 10, a plurality of electrical terminals 20 disposed in the insulating housing 10, and a shielding shell 30 enclosing the insulating housing 10 together with the electrical terminals 20.

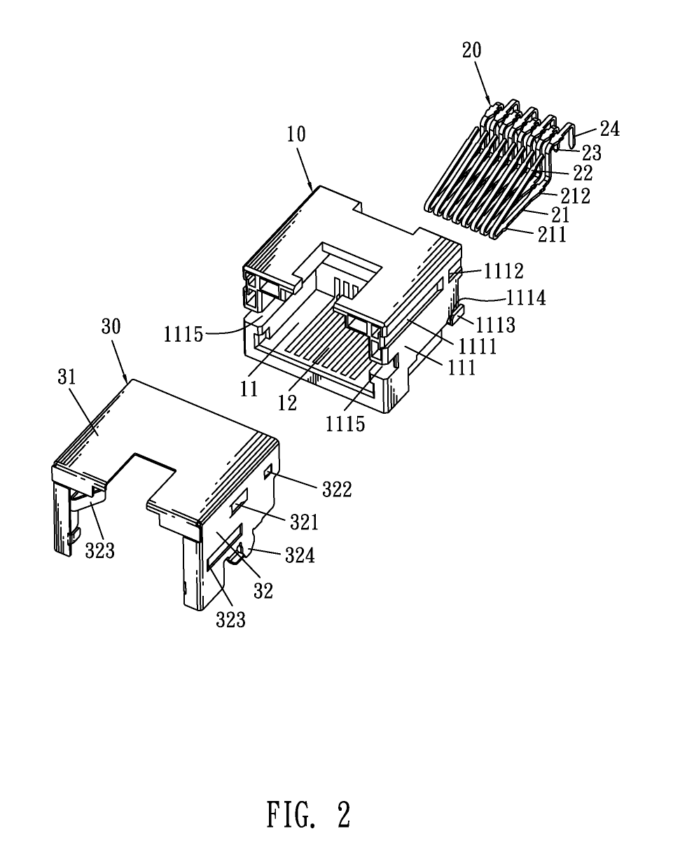

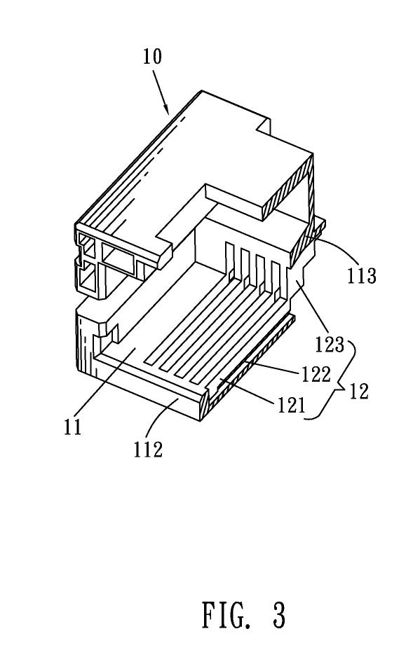

Referring to FIG. 2 and FIG. 3, the insulating housing 10 is of a rectangular shape and defines a substantially rectangular receiving chamber 11 having a front opened freely, and a plurality of terminal fillisters 12 communicated with the receiving chamber 11. The terminal fillisters 12 are transversely arranged at regular intervals in a bottom wall 112 of the receiving chamber 11 and each further extends longitudinally to penetrate through a rear wall 113 of the receiving chamber 11. Each of the terminal fillisters 12 includes a positioning fillister 121 longitudinally opened on the bottom wall 112, an inserting fillister 123 opened in the rear wall 113 to be connected with the positioning fillister 121, and a pair of fastening fillisters 122 oppositely concaved inward into two opposite inner sides of the positioning fillister 121. The receiving chamber 11 further has two side walls 111 of which two opposite outsides are respectively designed with a first fixing groove 1111 at a front thereof and a second fixing groove 1112 at a rear thereof, and two face-to-face inner sides are designed with a pair of fixing cavities 1115 at fronts thereof. A rear portion of a bottom edge of each side wall 111 protrudes outward and then upward to form a restraining portion 1113 with a restraining slot 1114 being formed between the restraining portion 1113 and the outside of the side wall 111.

Referring to FIG. 2 again, the electrical terminal 20 has a base arm 21 of a long strip shape, a fastening arm 23 extending upward from a rear end of the base arm 21, a contact arm 22 extending upward from a front end of the base arm 21 and inclined towards the fastening arm 23 at an acute angle with respect to the base arm 21, and a soldering tail 24 formed at a distal end of the fastening arm 23. The front end of the base arm 21 has two opposite side edges thereof oppositely protruded outward to form a pair of fastening ears 211 adjacent to the contact arm 22. The rear end of the base arm 21 has two opposite side edges thereof oppositely protruded outward to form a pair of fixing ears 212.

Referring to FIG. 2 again, the shielding shell 30 has a base board 31 and two side boards 32 perpendicularly extending downward from two opposite side edges of the base board 31. Each of the side boards 32 is punched inward to form a bucking slice 322 at a rear thereof, a buckling portion 321 at a substantial middle thereof, and a locking slice 323 inclined rearward at a front thereof. A bottom edge of the side board 32 protrudes downward to form a fixing foot 324.

Referring to FIGS. 1-3, in assembly, the electrical terminals 20 are disposed in the terminal fillisters 12 of the insulating housing 10, with the base arm 21 being positioned in the positioning fillister 121, the contact arm 22 projecting into the receiving chamber 11, and the fastening arm 23 being fastened in the inserting fillister 123, wherein a free end of the contact arm 22 is movably restrained in the inserting fillister 123. The soldering tail 24 stretches behind the insulating housing 10 to be soldered with a printed circuit board (not shown). The fixing ears 212 are stabbed in the fastening fillisters 122 to secure the base arm 21 in the positioning fillister 121. The fastening ears 211 are stabbed in fronts of the fastening fillisters 122 to avoid the front end of the base arm 21 curling upward and rearward when a mating plug connector (not shown) is inserted into the receiving chamber 11 to press the contact arms 22 downward. Then, the shielding shell 30 is put around the insulating housing 10, with the base board 31 being covered on a top side of the insulating housing 10, and the side boards 32 abutting against the two opposite outsides of the side walls 111. The buckling portion 321 is buckled in the first fixing groove 1111, the buckling slice 322 is buckled in the second fixing groove 1112, and a bottom of the side board 32 is clipped in the restraining slot 1114. The locking slices 323 stretch into the receiving chamber 11 for securing the plug connector in the receiving chamber 11, and can be elastically pressed into the corresponding fixing cavities 1115 when the plug connector is inserted into the receiving chamber 11. The fixing feet 324 are inserted into the printed circuit board to secure the receptacle connector to the printed circuit board.

As described above, the fastening ears 211 are oppositely protruded at the two opposite side edges of the front end of the base arm 21 and further stabbed in the fronts of the fastening fillisters 122, so as to prevent the front end of the base arm 21 from curling upward and rearward when the mating plug connector is inserted into the receiving chamber 11 to press the contact arms 22 downward. So, it reduces fracture probability of the electrical terminal 20 and further prolongs use life of the electrical terminal 20 so as to realize a steady connection between the receptacle connector and the plug connector.

What is claimed is:

1. A receptacle connector adapted to connect with a mating plug connector, comprising:
an insulating housing defining a receiving chamber having a front opened freely for receiving the plug connector therein, and a plurality of terminal fillisters communicated with the receiving chamber, the terminal fillisters being transversely arranged at regular intervals in a bottom wall of the receiving chamber and each further extending longitudinally to penetrate through a rear wall of the receiving chamber, each of the terminal fillisters including a positioning fillister longitudinally opened on the bottom wall and a pair of fastening fillisters oppositely concaved inward into two opposite inner sides of the positioning fillister; and
a plurality of electrical terminals of which each has a base arm disposed in the positioning fillister of the insulating housing, a soldering tail formed at a rear end of the base arm to stretch behind the insulating housing, and a contact arm extending upward from a front end of the base arm and inclined rearward at an acute angle with respect to the base arm, the contact arm stretching into the receiving chamber for electrically connecting with the plug connector, the front end of the base arm having two opposite side edges thereof oppositely protruded outward to form a pair of fastening ears adjacent to the contact arm, the fastening ears being stabbed in fronts of the fastening fillisters to avoid the front end of the base arm curling upward and rearward when the plug connector is inserted into the receiving chamber.

2. The receptacle connector as claimed in claim 1, wherein the rear end of the base arm has two opposite side edges thereof oppositely protruded outward to form a pair of fixing ears stabbed in the fastening fillisters to secure the base arm in the positioning fillister.

3. The receptacle connector as claimed in claim 1, wherein the electrical terminal further has a fastening arm extending upward from the rear end of the base arm, the soldering tail is formed at a distal end of the fastening arm, the terminal fillister further includes an inserting fillister opened in the rear wall to be connected with the positioning fillister, the fastening arm is fastened in the inserting fillister, and a free end of the contact arm is movably restrained in the inserting fillister.

4. The receptacle connector as claimed in claim 1, further comprising a shielding shell which has a base board covered on a top side of the insulating housing, and two side boards extending downward from two opposite side edges of the base board to abut against two opposite outsides of two side walls of the receiving chamber.

5. The receptacle connector as claimed in claim 4, wherein the two opposite outsides of the side walls are respectively designed with a first fixing groove and a second fixing groove, each of the side boards is punched inward to form a bucking slice at a rear thereof to be buckled in the second fixing groove, and a buckling portion at a substantial middle thereof to be buckled in the first fixing groove.

6. The receptacle connector as claimed in claim 4, wherein two face-to-face inner sides of the side walls are designed with a pair of fixing cavities at fronts thereof, a front of the side board is punched inward to form a locking slice further inclined rearward to stretch into the receiving chamber for securing the plug connector in the receiving chamber, the locking slice can be elastically pressed into the corresponding fixing cavity when the plug connector is inserted into the receiving chamber.

7. The receptacle connector as claimed in claim 4, wherein a rear portion of a bottom of each side wall protrudes outward and then upward to form a restraining portion with a restraining slot being formed between the restraining portion and the outside of the side wall for clipping a bottom of the side board therein.
